(19) United States
(12) Patent Application Publication
(10) Pub. No.: US 2002/0033666 A1
(43) Pub. Date: Mar. 21, 2002

(54) Organic electroluminescent display

(76) Inventors: Yuji Mori, Urizura-machi (JP); Masato Shimura, Mobara-shi (JP); Yoshiharu Nagae, Hitachi-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/884,908

(22) Filed: Jun. 21, 2001

(30) Foreign Application Priority Data
Sep. 19, 2000 (JP) 2000-283899

(51) Int. Cl. H01J 1/62

(52) U.S. Cl. 313/504

(57) ABSTRACT

The present invention aims at the suppression of the generation of heat in an organic electroluminescent display. To achieve such an object, the organic electroluminescent display includes a transparent substrate, an organic light emitting layer which is formed on a back surface side of the transparent substrate, electric current supply means which makes the electric current flow through the organic light emitting layer, a housing which covers at least the organic light emitting layer and is sealed to the transparent substrate, and heat radiation material in a liquid form which is filled in a space formed between the housing and the transparent substrate.

### BACKGROUND OF THE INVENTION

(1) Field of the Invention

The present invention relates to an organic electroluminescent display.

(2) Description of the Related Art

An organic electroluminescent display includes an organic electroluminescent layer and also includes a display part which is constituted of a large number of pixels in the direction of extension of this organic electroluminescent layer.

For example, one electrodes which are extended in the x direction and are arranged in parallel in the y direction are formed on one surface of the organic electroluminescent layer and the other electrodes which are extended in the y direction and are arranged in parallel in the x direction are formed on the other surface of the organic electroluminescent layer, whereby pixels are formed at portions where one electrodes and the other electrodes are overlapped to each other.

In this case, when a potential is generated between one electrode and the other electrode on a given pixel, an electric current flows through the organic electroluminescent layer of the pixel so that the organic electroluminescent layer of the portion emits light.

In the organic electroluminescent display element having such a constitution, the light emission luminance has a tendency of monotonous increase with respect to the electric current so that the luminance can be increased by increasing the electric current.

However, in increasing the light emission luminance, the organic electroluminescent display device having such a constitution generates the Joule heat derived from the electric current so that it is difficult to prevent the elevation of the temperature of the device per se.

When the temperature of the device per se is elevated, the light emission efficiency is decreased and the flocculation of the organic material or the like is generated so that a drawback that the lifetime is shortened arises.

In general, there exists the relationship that the initial luminance×lifetime (time until the luminance is reduced by half relative to the initial luminance)=constant.

As countermeasures against the above mentioned drawback, the development of light emission material having high light emission efficiency even at the low electric current or the development of the material having high glass transition temperature of the positive hole transporting material which constitutes main material for forming the organic material can be considered.

However, the fact that these developments also generate heat does not change and further, a similar drawback arises when the display of high luminance is desired.

The present invention has been made in view of such a circumstance and it is an object of the present invention to provide an organic electroluminescent display which can suppress the generation of heat.

### SUMMARY OF THE INVENTION

To simply explain the summary of a typical invention among inventions disclosed in this application, it goes as follows.

An organic electroluminescent display device according to the present invention is characterized by including, for example, a transparent substrate, an organic light emitting layer formed on a back-surface side of the transparent substrate, electric current supply means which makes the electric current flow through the organic light emitting layer, a housing which covers at least the organic light emitting layer and is sealed by the transparent substrate, and a heat radiation material made of liquid filled between the housing and the transparent substrate.

With respect to the organic electroluminescent display having such a constitution, even when the Joule heat is generated in the organic light emitting layer due to the electric current, the heat is conducted to the heat radiation material made of liquid and the heat radiation material generates the convection due to the received heat.

Then, the heat derived from this convection is moved to the housing side and is radiated to the outside from this housing.

Accordingly, the Joule heat generated in the organic light emitting layer is not stored in the inside of the organic light emitting layer so that the organic light emitting layer is prevented from becoming the high temperature thus suppressing the lowering of the luminance.

### BRIEF DESCRIPTION OF THE DRAWING

FIG. 1A and FIG. 1B are constitutional views showing one embodiment of an organic electroluminescent display according to the present invention.

FIG. 2 is an explanatory view showing a mechanism of the light emission of an organic light emitting layer.

### DESCRIPTION OF THE PREFERRED EMBODIMENTS

An example of an organic electroluminescent display according to the present invention is explained hereinafter in conjunction with drawings.

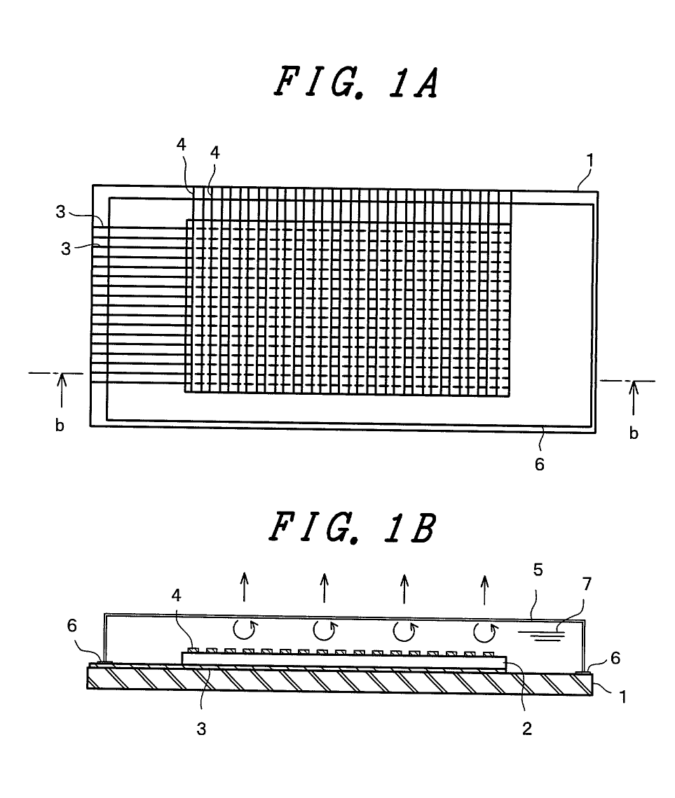

FIG. 1A is a plan view showing one embodiment of an organic electroluminescent display according to the present invention and FIG. 1B shows a cross section taken along a line b-b of FIG. 1A.

In respective drawings, a transparent substrate 1 made of a glass substrate, for example, is described. This transparent substrate 1 is arranged at a side which allows the observation of the display and hence, the observation can be made through this transparent substrate 1.

On a display part at a surface opposite to the observation side of the transparent substrate 1, an organic light emitting layer 2 and the electrodes 3, 4 which are served for making selected regions (pixel regions) among the surface of the organic light emitting layer 2 emit light are formed.

That is, first of all, on a surface corresponding to the above-mentioned display part of the transparent substrate 1, a large number of first electrodes 3 which are extended in the x direction and are arranged in parallel in the y direction are formed. Further, one ends (left ends in the drawing) of these first electrodes 3 are formed such that they are extended to a side portion of the transparent substrate 1.

Further, the organic light emitting layer 2 is formed on a surface of the transparent substrate 1 corresponding to the display part such that the organic light emitting layer 2 also covers the first electrodes 3.

This organic light emitting layer 2 is made of material such as tris (8-quinolinolate) aluminum and is formed by a vapor deposition technique or the like.

Further, on an upper surface of this organic light emitting layer 2, a large number of second electrodes 4 which are extended in the y direction and are arranged in parallel in the x direction are formed. Further, one ends (upper ends in the drawing) of these second electrodes 4 are formed such that they are extended to a side portion of the transparent substrate 1.

That is, in the organic light emitting layer having such a constitution, pixels are formed at portions where the first electrodes 3 and the second electrodes 4 are overlapped with each other and the display part is constituted of a mass of these respective pixels (arranged in a matrix array).

Then, for example, by sequentially supplying scanning signals (voltage) to the first electrodes 3 along the parallel-arrangement direction of the first electrodes 3 and by supplying video signals (voltage) to respective second electrodes 4 matching the timing of the supply of scanning signals, the organic light emitting layer 2 of each pixel emits light with the luminance corresponding to the electric current which flows through the organic light emitting layer 2.

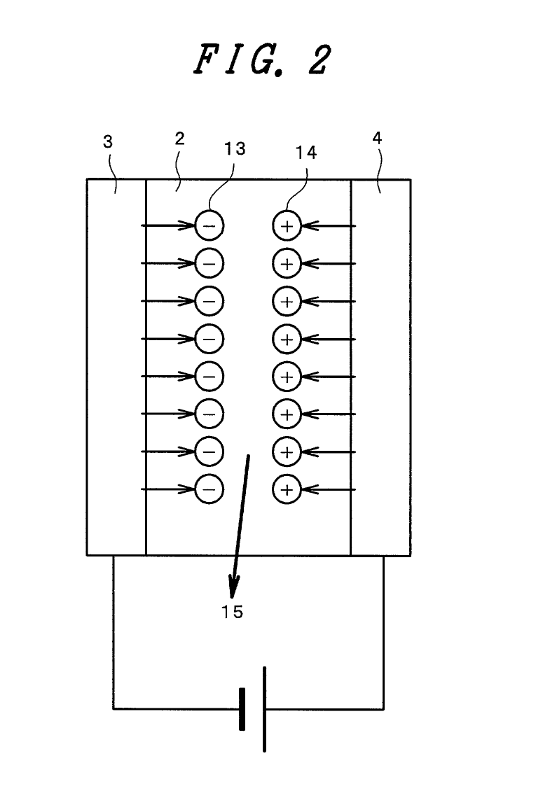

FIG. 2 is a view showing one example of a light emission mechanism of the organic light emitting layer 2 sandwiched by the electrodes 3, 4. In the drawing, electrons 13 are supplied from a cathode side of the electrode 3 to the organic light emitting layer 2 side and positive holes 14 are supplied from an anode side of the electrode 4 to the organic light emitting layer 2 side, and these electrons 13 and positive holes 14 are coupled again to irradiate light 15.

On the surface of the transparent substrate 1 on which the organic light emitting layer 2 and the electrodes 3, 4 which make respective pixel regions in the inside of the organic light emitting layer 2 emit light are formed in the above-mentioned manner, a housing 5 is arranged such that the housing 5 covers at least the above-mentioned organic light emitting layer 2, and the periphery of this housing 5 is fixedly secured to the transparent substrate 1 by means of a sealing agent 6.

That is, an envelope of the organic electroluminescent display is constituted of the housing 5 and the transparent substrate 1. In this embodiment, the housing 5 is formed of metal such as aluminum, copper, iron, stainless steel, brass, nickel or the like which is material having the large thermal conductivity.

A non-conducting liquid is filled in the inside of the envelope and this liquid is formed of a heat radiation material 7 which is chemically stable and has the large thermal conductivity. As material for such a heat radiation material 7, silicone oil may be selected.

Due to such a constitution, in the inside of the envelope, the periphery of the organic light emitting layer 2 excluding the transparent substrate 1 side is covered with the heat radiation material 7 so that even when the Joule heat is generated due to the electric current which flows through the organic light emitting layer 2 and hence, the temperature of the organic light emitting layer 2 is increased, the heat is readily conducted to the housing 5 side due to the convection of the heat radiation material 7.

Further, since this heat is radiated to the inside of the atmosphere through the housing 5, there is no possibility that the heat is stored in the organic light emitting layer 2 and hence, the lowering of the luminance can be prevented.

Although metal is used as the material of the housing 5 in the above-mentioned embodiment, the material is not always limited to the metal. This is because that any material which has the favorable thermal conductivity can obtain the same advantageous effect.

Further, although the above-mentioned embodiments are constituted such that respective electrodes 3, 4 which are formed on the organic light emitting layer 2 are directly extended such that signals can be supplied from the outside of the envelope, it is needless to say that the present invention is applicable to a constitution where a drive circuit is mounted in the inside of the envelope and outputs from this drive circuit are supplied to respective electrodes 3, 4.

Further, in the above-mentioned embodiments, the electrodes 3, 4 which make the electric current flow through respective pixel regions of the organic light emitting layer 2 have one electrodes extended in the x direction and arranged in parallel in the y direction and the other electrodes extended in the y direction and arranged in parallel in the x direction. However, it is needless to say that the present invention is not limited to such a constitution. This is because that so long as the electric current is made to flow through the organic light emitting layer 2, a similar task to be solved arises.

As can be clearly understood from the above-mentioned explanation, according to the organic electroluminescent display of the present invention, the generation of the heat can be suppressed.

Here, in the case that water is mixed into the inside of the heat radiation material in a liquid form as impurity, when a quantity of water as the impurity is large, it gives rise to an influence that a large number of dark spots (non-luminance points) are present. Accordingly, it is preferable that with respect to the heat radiation material which can be used in the present invention, a quantity of water which is contained in the heat radiation material as impurity amounts to not more than 100 ppm by weight ratio.

What is claimed is:

1. An organic electroluminescent display comprising:
a transparent substrate,
an organic light emitting layer which is formed on a back surface side of the transparent substrate,
electric current supply means which makes an electric current flow through the organic light emitting layer,
a housing which covers at least the organic light emitting layer and is sealed to the transparent substrate, and
heat radiation material in a liquid form which is filled in a space formed between the housing and the transparent substrate.

2. An organic electroluminescent display according to claim 1, wherein the housing is formed of metal.

3. An organic electroluminescent display according to claim 1, wherein the heat radiation material in a liquid form is silicone oil.

4. An organic electroluminescent display according to claim 1, wherein water which is contained in the heat radiation material as impurity amounts to not more than 100 ppm by weight ratio.

5. An organic electroluminescent display comprising:
a transparent substrate,
first electrodes which are extended in the x direction and are arranged in parallel in the y direction on a display region at a back surface side of the transparent substrate,
an organic light emitting layer which is formed on the display region such that the organic light emitting layer also covers the first electrodes,
second electrodes which are extended in the y direction and are arranged in parallel in the x direction on a surface of the organic light emitting layer,
a metal housing which covers at least the organic light emitting layer and is sealed to the transparent substrate, and
a non-conducting liquid which is filled in a space formed between the housing and the transparent substrate.

6. An organic electroluminescent display according to claim 5, wherein the first electrodes are formed such that one ends thereof are extended and reach the outside of the housing and the second electrodes are formed such that one ends thereof are extended and reach the outside of the housing.

7. An organic electroluminescent display according to claim 5, wherein water which is contained in the non-conducting liquid as impurity amounts to not more than 100 ppm by weight ratio.
